(19) United States
(12) Patent Application Publication
(10) Pub. No.: US 2009/0004532 A1
(43) Pub. Date: Jan. 1, 2009

(54) Dummy cassettes for a solid oxide fuel cell stack

(76) Inventors: Karl J. Haltiner, JR., Fairport, NY (US); Peter E. Hendler, Rochester, NY (US)

Correspondence Address: DELPHI TECHNOLOGIES, INC., M/C 480-410-202, PO BOX 5052, TROY, MI, 48007, US

(21) Appl. No.: 11/823,618

(22) Filed: Jun. 28, 2007

(51) Int. Cl. H01M 2/14

(52) U.S. Cl. 429/34

(57) ABSTRACT

A fuel cell stack assembly comprising a plurality of serially-assembled fuel cell stages formed as individual cassette units, wherein at least one of the first and last cassettes, and preferably both, is a dummy cassette assembled with a metal blank in place of the fuel cell, which metal blank preferably is formed integrally with a dummy picture frame element. A dummy cassette contains an interconnect, flow blocking anode spacers, metal contact paste, and a separator plate to assure electrical conductivity and structural integrity in the assembled fuel cell stack. Providing the dummy cassettes corrects a known problem of underperformance of the end fuel cell cassettes which limits the performance of the entire stack.

### RELATIONSHIP TO GOVERNMENT CONTRACTS

The present invention was supported in part by a US Government Contract, No. DE-FC26-02NT41246. The United States Government may have rights in the present invention.

### TECHNICAL FIELD

The present invention relates to fuel cell stacks; more particularly to a solid oxide fuel cell stack comprising a plurality of fuel cell cassettes; and most particularly to such a fuel cell stack wherein at least one of the cassettes is intentionally non-functional (a “dummy” cassette).

### BACKGROUND OF THE INVENTION

In practical fuel cell systems, the output of a single fuel cell is typically less than one volt, so connecting multiple cells in series is required to achieve useful operating voltages. Typically, a plurality of fuel cell stages, each stage comprising a single fuel cell unit, are mechanically stacked up in a “stack” and are electrically connected in series electric flow from the anode of one cell to the cathode of an adjacent cell via intermediate stack elements known in the art as interconnects and separator plates.

A solid oxide fuel cell (SOFC) comprises a cathode layer, an electrolyte layer formed of a solid oxide bonded to the cathode layer, and an anode layer bonded to the electrolyte layer on a side opposite from the cathode layer. In use of the cell, air is passed over the surface of the cathode layer, and oxygen from the air migrates through the electrolyte layer and reacts in the anode with hydrogen being passed over the anode surface, forming water and thereby creating an electrical potential between the anode and the cathode of about 1 volt. Typically, each individual fuel cell is mounted, for handling, protection, and assembly into a stack, within a metal frame referred to in the art as a “picture frame”, to form a “cell-picture frame assembly”.

To facilitate formation of a prior art stack of fuel cell stages wherein the voltage formed is a function of the number of fuel cells in the stack, connected in series, a known intermediate process for forming an individual fuel cell stage joins together a cell-picture frame assembly with an anode interconnect and a metal separator plate to form an intermediate structure known in the art as a fuel cell cassette (“cassette”). The thin sheet metal separator plate is stamped and formed to provide, when joined to the mating cell frame and anode spacers, a flow space for the anode gas. Typically, the separator plate is formed of ferritic stainless steel for low cost.

In forming the stack, the cell-pic frame assembly of each cassette is sealed to the perimeter of the metal separator plate of the adjacent cassette to form a cathode air flow space and to seal the feed and exhaust passages for air and hydrogen against cross-leaking or leaking to the outside of the stack.

It has been observed in SOFC stacks formed of planar cassettes that the endmost cells in the stack perform substantially differently from those in the remainder of the stack. Specifically, the end cells typically exhibit 20-40% lower voltage output than do the rest of the cells. Such lower performing cells may limit the operation of the overall stack. For example, it is undesirable to operate a cell below about 0.5 volts for risk of damaging the cell. If the top and bottom cassettes of a stack are operating at 0.5 volts at a current level at which the rest of the cassettes are operating at 0.8 volts, the stack average voltage is well above the desirable average of 0.7 volts. No more current load may be imposed on the stack, which would be desirable to bring the stack average voltage to 0.7, without causing the top and bottom cassettes to operate at less, than 0.5 volts. Failure of the top or bottom cassette can cause overall stack failure.

What is needed in the art is a means to allow operation of a stack at a desired average voltage of about 0.7 without causing any of the individual fuel cells to operate below 0.5 volts.

It is a principal object of the present invention to increase the potential power output of a fuel cell stack without jeopardizing the functionality of any of the fuel cells.

### SUMMARY OF THE INVENTION

Briefly described, a fuel cell stack in accordance with the invention comprises a plurality of serially-assembled fuel cell stages preferably formed as individual cassette units. To correct a known problem of underperformance of the end cassettes in the stack, at least one of the first and last cassettes, and preferably both, is a dummy cassette assembled with a metal blank in place of the fuel cell, which metal blank preferably is formed integrally with a dummy picture frame element. A dummy cassette contains an interconnect, flow blocking anode spacers, contact paste, and a separator plate to assure electrical conductivity and structural integrity in the assembled fuel cell stack.

### BRIEF DESCRIPTION OF THE DRAWINGS

The present invention will now be described, by way of example, with reference to the accompanying drawings, in which:

FIG. 1 is a schematic drawing of an SOFC mounted in a frame;

FIG. 2 is an exploded isometric drawing of a portion of a fuel cell stack employing a plurality of single-cell cassettes;

FIG. 3 is a plan view of a functional fuel cell cassette;

FIG. 4 is a plan view of a dummy cassette in accordance with the present invention;

FIG. 5 is an exploded isometric view of the dummy cassette shown in FIG. 4; and

FIG. 6 is an exploded isometric view of a complete fuel cell stack employing dummy cassettes in the first and last cassette positions in accordance with the invention.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

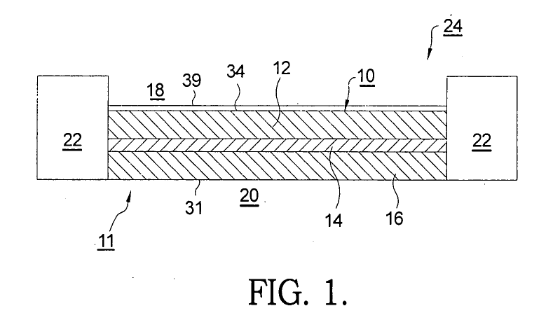

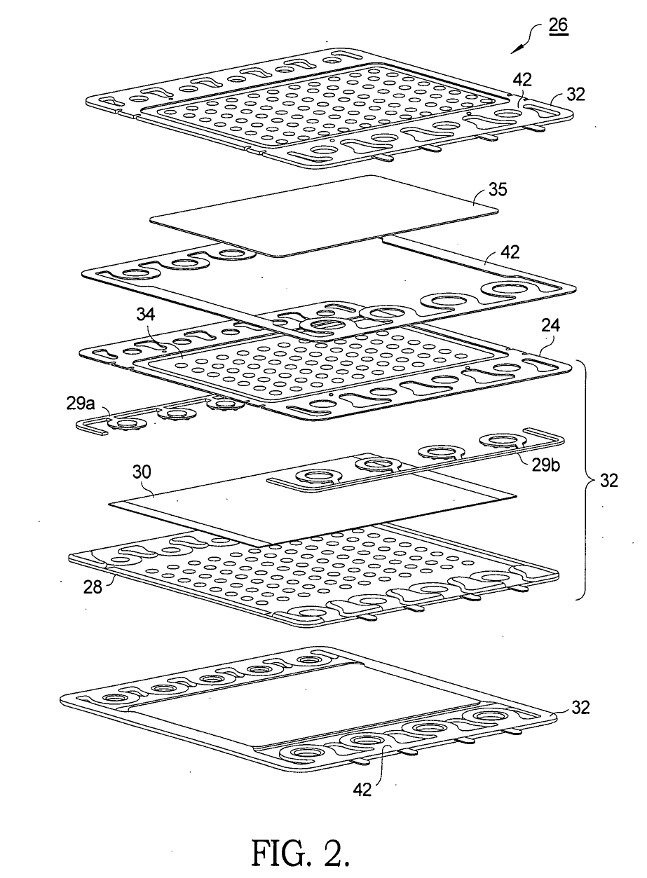

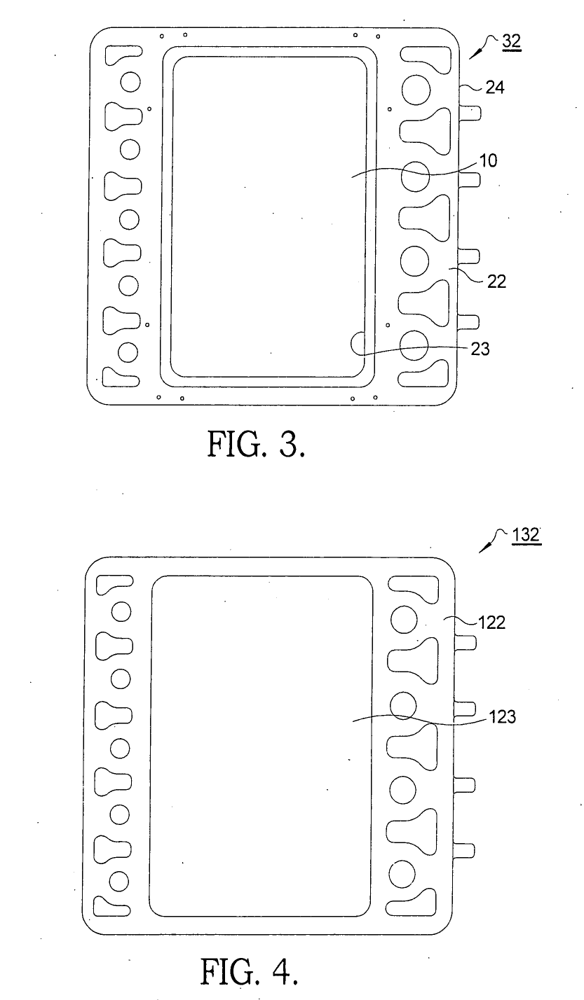

Referring to FIGS. 1 through 3, an exemplary functional SOFC fuel cell module 10 comprises an electrode 11 including cathode layer 12, an electrolyte layer 14 formed of a solid oxide and bonded to the cathode layer 12, and an anode layer 16 bonded to the electrolyte layer 14 on a side opposite from the cathode layer. Air 18 is passed over the surface 34 of the cathode layer 12, and oxygen from the air migrates through the electrolyte layer 14 and reacts in the anode layer 16 with hydrogen anode gas 20 being passed over the anode surface 31 to form water, thereby creating an electrical potential between the anode and the cathode of about 1 volt. Each individual fuel cell module 10 is mounted, for handling; protection, and assembly into a stack, within a metal frame 22 referred to in the art as a “picture frame”, the frame having a central opening or “window” 23, to form a “cell-picture frame assembly” 24.

To facilitate formation of a stack 26 of individual fuel cells connected in series wherein the voltage formed is a function of the number of individual fuel cell modules in the stack, an intermediate process joins together each cell-picture frame assembly 24 with a separator plate 28 and a first solid (anode) interconnect 30 to form an intermediate structure known as a fuel cell cassette 32. The thin sheet metal separator plate 28 is stamped and formed to provide, when joined to the mating cell frame 22 and inlet and outlet anode spacers 29a,29b, a flow space for the anode gas 20. Preferably, the separator plate 28 is formed of ferritic stainless steel for low cost. Anode interconnect 30 is placed between the separator plate 28 and the anode surface 31 of the cell within the cassette 32. The anode interconnect 30 is typically a woven wire mesh of uniform thickness and is solid in the direction perpendicular to the cell surface in a multitude of points.

A second solid (cathode) interconnect 35, installed during final assembly against cathode surface 34, provides a cathode air flow space. Interconnect 35 also is typically a woven wire mesh of uniform thickness and solid in the direction perpendicular to the cell surface in a multitude of points.

During the final prior art stack assembly process, a glass perimeter seal 42 is disposed between adjacent of the cassettes 32, and the stack under pressure is brought to operating temperature and allowed to settle to its final form. The separator plate and cell frame may deform slightly, providing a compliant assembly, until the cells and interconnects are resting on one another, under load, which prevents further motion.

The present invention provides the capability to increase the maximum load demand on a fuel cell stack without increasing the size or number of individual fuel cells in the stack and without damage thereto. The invention provides a very effective and economical solution to an end effect problem known in the prior art: add non-functional but mechanically identical dummy cassettes to the top and/or bottom of a stack of functional cassettes.

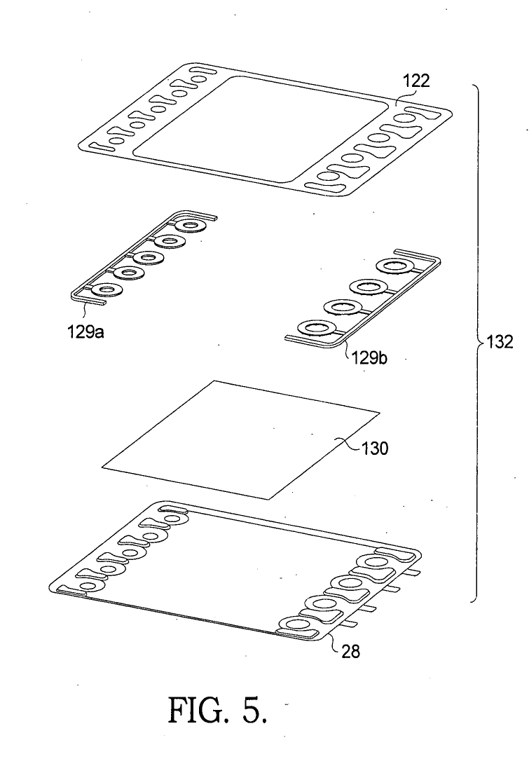

Referring now to FIGS. 4 through 6, a dummy cassette 132 in accordance with the invention comprises a picture frame element 122 having a solid metal center portion 123 in place of electrode 11. Solid metal portion 123, while dimensionally mimicking prior art window 23 and fuel cell 10, does not include an anode layer, a cathode layer and an electrolyte layer. Preferably, solid metal center portion 123 is formed, integrally with the surround of frame element 122 in a single stamping process, to minimize the total number of components. Alternatively, center portion 123 may be provided as a metal slab having the same dimensions as prior art fuel cell 10 which may be installed in a prior art picture frame 22 in place of the fuel cell. When formed integrally, center portion 123 is recessed below the upper surface of the surround portion to allow space for a cathode spacer (not shown) to ensure electrical continuity and mechanical integrity of the assembled fuel cell stack.

Dummy cassette 132 is formed similarly to a prior art fuel cell cassette 32. A separator plate 28 is bonded as by welding to picture frame element 122 to capture an anode interconnect 130 and flow blocking inlet and outlet anode spacers 129a,129b. Preferably, anode inlet spacers 129a are the same thickness as anode spacers 29 but lack the channels formed in the spacer rings of prior art spacers 29 such that the normal flow of anode fuel gas is prevented from entering and leaving the anode gas flow space formed within separator plate 28, which flow would be completely wasteful of the fuel gas. In one aspect of the invention, one set of channels is left open to allow a very low is flow of fuel gas to pass through this space to assist in burning off the binder in the contact paste used for all electrical contact within the dummy cassette to ensure electrical continuity.

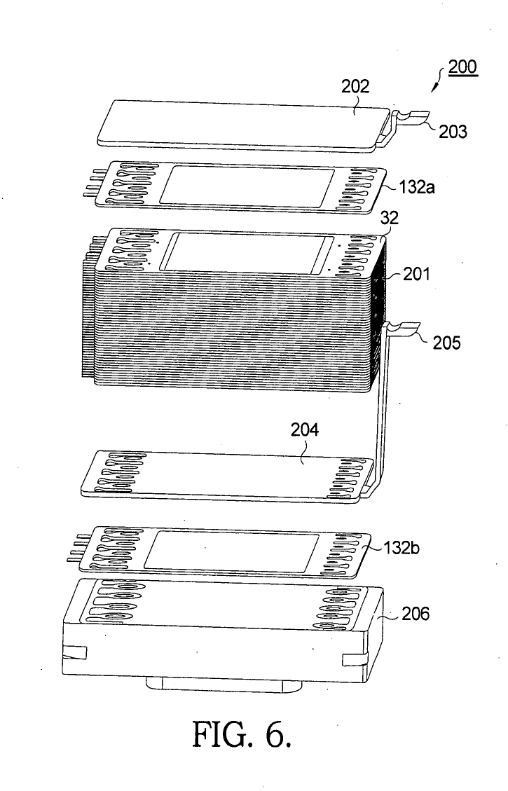

Referring to FIG. 6, a complete fuel cell stack assembly 200 in accordance with the invention comprises a central stack portion 201 of n number of functional fuel cell cassettes 32. A first dummy cassette 132a is disposed at the upper end of the stack between the first of the functional cassettes 32 and an upper current collector 202 having a first connector 203. Stack portion 201 is bounded at its lower end by a second current collector 204 having a second connector 205. In one aspect of the invention, second dummy cassette 132b is disposed between second collector 204 and a base manifold 206 for distributing fresh cathode air and anode fuel gas to the stack and for recovering spent cathode air and anode tailgas therefrom in known fashion. Alternatively, second dummy cassette 132b may be disposed between stack portion 201 and second current collector 204.

A complete stack in accordance with the invention may comprise:

n cassettes wherein n−2 cassettes are fuel cell cassettes and the two end cassettes are dummy cassettes; or

n cassettes wherein n−1 cassettes are fuel cell, cassettes and one end cassette is a dummy cassette; or

n+1 cassettes wherein n cassettes are fuel cell cassettes and one end cassette is a dummy cassette; or

n+2 cassettes wherein n cassettes are fuel cell cassettes and the two end cassettes are dummy cassettes. That is, an improved stack having at least one dummy cassette may fit within an existing footprint of n cassettes or may be expanded by one or two total cassettes, as may be desired.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A dummy cassette for a fuel cell stack assembly comprising a picture frame element having a solid center portion wherein said solid center portion does not including an electrode.

2. A dummy cassette for a fuel cell stack assembly, comprising:
a) a picture frame element having a peripheral portion and a solid center portion; and
b) a flow blocking anode inlet spacer adjacent said picture frame element;
c) an anode outlet spacer adjacent said picture frame element;
d) an anode interconnect adjacent said solid center portion; and
f) a separator plate bonded to said picture frame to enclose said flow blocking anode inlet spacer, said anode outlet spacer, and said anode interconnect.

3. A dummy cassette in accordance with claim 2 further comprising a metal contact paste for providing electrical conductivity within said cassette between said separator plate and said solid center portion through said interconnect.

4. A dummy cassette in accordance with claim 2 wherein said dummy cassette is mechanically and dimensionally identical to a functional fuel cell cassette for use in said fuel cell stack.

5. A dummy cassette in accordance with claim 2 wherein said solid center portion is substantially identical in dimensions to a window and fuel cell portion of a functional fuel cell cassette for use in said fuel cell stack.

6. A dummy cassette in accordance with claim 2 wherein said solid center portion is formed integrally with said peripheral portion.

7. A dummy cassette in accordance with claim 2 wherein said solid center portion is a metal slab bonded to said peripheral portion.

8. A dummy cassette in accordance with claim 2 wherein said peripheral portion is a picture frame suitable for use in a functional fuel cell cassette.

9. A fuel cell stack assembly comprising:
a) a stack portion including n number of functional fuel cell cassettes; and
b) at least one dummy cassette disposed adjacent said stack portion.

10. A fuel cell stack assembly in accordance with claim 9 further comprising:
a) a first current collector disposed at a first end of said stack;
b) a distribution manifold disposed at a second end of said stack; and
c) a second current collector disposed between said stack portion and said distribution manifold.

11. A fuel cell stack assembly in accordance with claim 10 wherein said at least one dummy cassette is disposed between said stack portion and said first current collector or above current collector.

12. A fuel cell stack assembly in accordance with claim 10 wherein said at least one dummy cassette is disposed adjacent said second current collector.

13. A fuel cell stack assembly in accordance with claim 12 wherein said at least one dummy cassette is disposed between said second current collector and said stack portion.

14. A fuel cell stack assembly in accordance with claim 12 wherein said at least one dummy cassette is disposed between said second current collector and said distribution manifold.

15. A fuel cell stack assembly in accordance with claim 9 comprising two dummy cassettes.

16. A fuel cell stack assembly in accordance with claim 15 wherein a first dummy cassette is disposed between said stack portion and a first current collector and a second dummy cassette is disposed adjacent a second current collector.

17. A fuel cell stack assembly in accordance with claim 9 wherein said dummy cassette is configured to block a flow of anode fuel from passing through said dummy cassette.

18. A fuel cell stack assembly in accordance with claim 9 wherein said dummy cassette is configured to permit some anode fuel to flow through said dummy cassette.
